(19) United States
(12) Patent Application Publication
(10) Pub. No.: US 2016/0237832 A1
(43) Pub. Date: Aug. 18, 2016

(54) ABRASIVE BLADE TIP WITH IMPROVED WEAR AT HIGH INTERACTION RATE

(71) Applicant: UNITED TECHNOLOGIES CORPORATION, Hartford, CT (US)

(72) Inventor: Christopher W. Strock, Kennebunk, ME (US)

(21) Appl. No.: 14/620,310

(22) Filed: Feb. 12, 2015

(51) Int. Cl. F01D 5/28; F01D 9/04; B05D 7/24

(52) U.S. Cl. CPC F01D 5/288; B05D 7/24; F01D 9/041; F05D 2220/30; F05D 2230/90; F05D 2240/125; F05D 2240/307; F05D 2300/611; F05D 2300/516; F05D 2250/63

(57) ABSTRACT

An abrasive blade tip coating comprising a blade tip having a top surface. A plurality of first grit particles are dispersed over the top surface of the blade tip. A plurality of second grit particles are closely packed between each of the plurality of first grit particles. The second grit particles having a nominal size smaller than the first grit particles. A matrix material is bonded to the top surface. The matrix material envelops the second grit particles. The matrix material is also bonded to and partially surrounds the first grit particles, wherein the first grit particles extend above the matrix material and the second grit particles relative to the top surface.

### BACKGROUND

The present disclosure is directed to abrasive blade tip coating. More particularly, a composite structure that distributes cutting loads from individual highly loaded grit particles to adjacent grit particles, thus reducing stress at the matrix which holds individual grit particles of the abrasive blade tip coating.

Gas turbine engines and other turbomachines have rows of rotating blades contained within a generally cylindrical case. As the blades rotate, their tips move in close proximity to the case. To maximize engine operating efficiency, the leakage of the gas or other working fluid around the blade tips should be minimized. This may be achieved by blade and sealing systems in which the blade tips rub against a seal attached to the interior of the engine case. Generally, the blade tip is made to be harder and more abrasive than the seal; thus, the blade tips will cut into the seal during those portions of the engine operating cycle when they come into contact with each other.

During the operation of a gas turbine engine, it is desired to maintain minimum clearance between the tips of the turbine blades and the corresponding seals. A large gap results in decreased efficiency of the turbine, due to the escape of high-energy gases. Conversely, friction between the blades and seals causes excessive component wear and wastes energy. Since aircraft turbines experience cyclic mechanical and thermal load variations during operation their geometry varies during the different stages of the operating cycle. Active clearance control and abrasive blade tips are currently used to establish and maintain optimum clearance during operation. Ideally, those tips should retain their cutting action over many operating cycles compensating for any progressive changes in turbine geometry.

During certain engine operating conditions engines have shown very high radial interaction rate (˜40″/s) that cause rapid depletion of the abrasive grit portions of the abrasive blade tip coating when rubbed against the air seals.

The unwanted rubbing of exposed blade tips, such as Ti blade material, results from the depletion of the abrasive blade tip coating. This results in Ti blade material contact with the abradable material of the air seal. The Ti blade material contact with the abradable where the abrasive has been depleted can create Ti sparking which may cause unwanted conditions within the gas turbine engine.

An abrasive tip is needed that provides a higher wear ratio with abradable outer air seal material at the high interaction rates associated with certain off-normal engine operating conditions, such as, a bird strike and surge.

### SUMMARY

In accordance with the present disclosure, there is provided an abrasive blade tip coating comprising a blade tip having a top surface. A plurality of first grit particles are dispersed over the top surface of the blade tip. A plurality of second grit particles are closely packed between each of the plurality of first grit particles. The second grit particles having a nominal size smaller than the first grit particles. A matrix material is bonded to the top surface. The matrix material envelops the second grit particles. The matrix material is also bonded to and partially surrounds the first grit particles, wherein the first grit particles extend above the matrix material and the second grit particles relative to the top surface.

In an exemplary embodiment, the first grit particles comprise a SiC material.

In an exemplary embodiment, the matrix material comprises a matrix formed from MCrAlY, wherein M is Ni or Co.

In an exemplary embodiment, the second grit particles comprise the same material as said first grit particles.

In an exemplary embodiment, an adhesion layer is coupled to the top surface, wherein the adhesion layer is configured to adhere the first grit particles to the top layer.

In an exemplary embodiment, the adhesion layer comprises the same material as the matrix material.

In an exemplary embodiment, the matrix material and the second grit particles combined comprise a modulus of elasticity greater than the matrix material alone.

In another exemplary embodiment, a turbine engine component comprises an airfoil portion on having a tip; a composite abrasive coating bonded to the tip; the composite abrasive coating comprises an adhesion layer bonded to the tip. A layer of first grit particles is bonded to the adhesion layer. A plurality of second grit particles are dispersed around the first grit particles, the second grit particles being smaller than the first grit particles; and the second grit particles are enveloped in a matrix material surrounding an unexposed portion of the first grit particles. The matrix material is coupled to the adhesion layer.

In an exemplary embodiment, the first grit particles are sized from about 0.04 to about 0.15 millimeters.

In an exemplary embodiment, the second grit particles are sized from 0.01 to about 0.1 millimeters.

In an exemplary embodiment, the matrix material and the second grit particles are configured to distribute a cutting load from individual highly loaded first grit particles to adjacent first grit particles, thereby reducing stress at the matrix material.

In an exemplary embodiment, each one of the first grit particles are configured with a grit spacing configured to protect the matrix material from wear by an abradable rub.

In an exemplary embodiment, the turbine engine component is a blade.

In another exemplary embodiment, a process for coating a turbine engine blade with an abrasive comprises applying an adhesion layer onto a tip of said blade; adhering a plurality of first grit particles to the adhesion layer, wherein narrow spaces are formed between the first grit particles; filling the narrow spaces between the first grit particles with a plurality of second grit particles, wherein the second grit particles are smaller than the first grit particles; enveloping the second grit particles with a matrix material; surrounding each of the first grit particles with the matrix material exposing a portion of the first grit particles above the matrix material and the second grit particles.

In an exemplary embodiment, the further comprises spacing the first grit particles apart, wherein the spacing is configured to protect the matrix material from wear by an abradable rub.

In an exemplary embodiment, the process further comprises distributing a cutting load from individual highly loaded first grit particles to adjacent first grit particles, thereby reducing stress at the matrix composite material.

In an exemplary embodiment, the matrix material and the second grit particles combined comprise a modulus of elasticity greater than said matrix material alone.

In an exemplary embodiment, the process further comprises applying a base layer to the blade tip prior to applying the adhesion layer.

Other details of the abrasive blade tip coating are set forth in the following detailed description and the accompanying drawing wherein like reference numerals depict like elements.

### BRIEF DESCRIPTION OF THE DRAWINGS

FIG. 1 is a schematic representation of abrasive composite coating applied to a tip of a turbine engine component; and

FIG. 2 is a schematic cross-sectional view of the exemplary abrasive blade tip coating.

### DETAILED DESCRIPTION

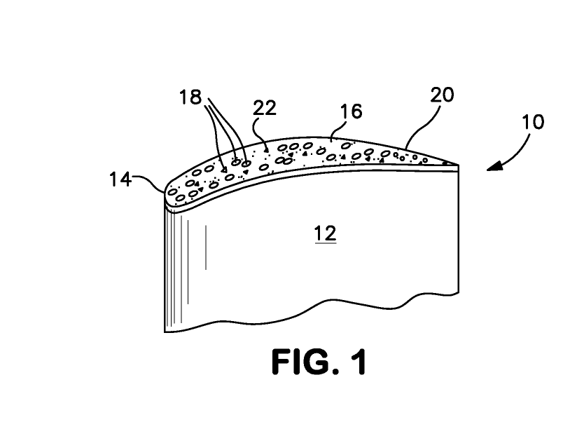

Referring now to FIG. 1 there is illustrated a turbine engine component 10, such as a compressor blade or vane. The blade 10 has an airfoil portion 12 with a tip 14. The tip 14 has an abrasive coating 16 applied to it. The abrasive coating 16, comprises a composite material that includes an abrasive particulate/grit or simply first grit 18, such as cubic boron nitride (CBN), coated Silicon carbide (SiC), or another hard ceramic phase. The grit 18 can be sized as a coarse grit. In an exemplary embodiment the grit 18 can be sized from about 70 to about 150 microns. The first grit 18 is embedded in a plating layer matrix composite 20. The matrix 20 comprises a suitable oxidation-resistant alloy matrix. In an exemplary embedment the plating layer comprises a matrix formed from MCrAlY, the M standing for either Ni or Co or both. In an exemplary embodiment, the matrix 20 can comprise pure nickel, nickel alloy, copper, copper alloy, cobalt, cobalt alloy, or chrome alloy. A second grit 22 is interspersed between the first grit 18. The second grit 22 is a smaller sized particle than the larger first grit material 18. In an exemplary embodiment, the second grit 22 is sized to about ⅔ the size of the first grit 18. The second grit 22 can be from about 10% to about 50% of the diameter of the first grit 18. The spaces between the first grit 18 and second grit 22 are filled in with the plating layer 20. The resulting blade tip 14 with abrasive coating 16 is particularly well suited for rubbing metal as well as ceramic air seals (not shown).

The turbine engine component/blade 10 may be formed from a titanium-based alloy or a nickel-based alloy. In an exemplary embodiment, the blade 10 includes a (Ti) titanium-based alloy.

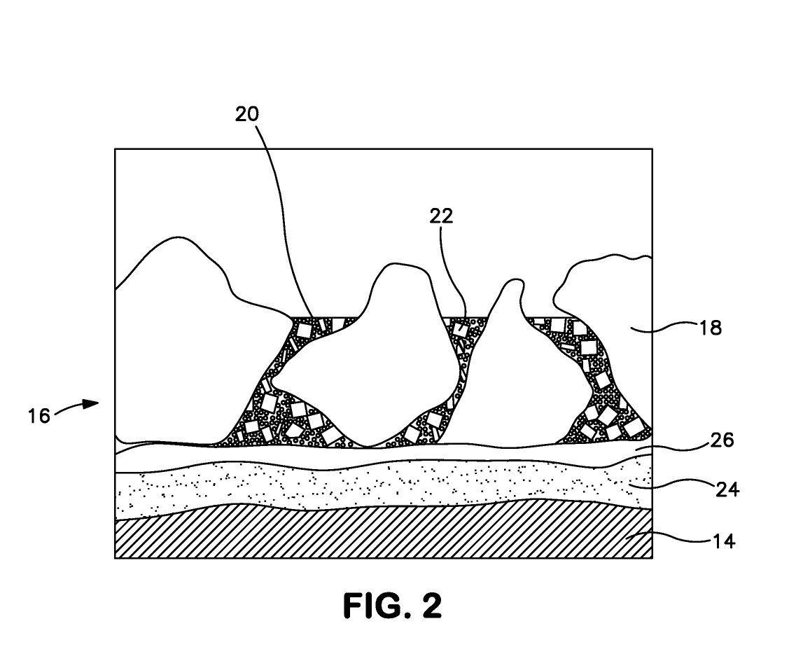

Referring to FIG. 2 an exemplary abrasive coating 16 is shown. The abrasive coating 16 includes the large first grit particles 18 and relatively smaller second grit particles 22 interspersed throughout the matrix 20.

In an exemplary embodiment, the first grit particles 18 range in size from about 0.04 to about 0.15 millimeters (mm) nominally. First grit 18 particle sizes can range up to about 0.15 mm nominally.

The first grit particles 18 are narrowly spaced apart. The narrow spacing can provide protection from abrasion to the matrix composite material 20 located between each first grit particle 18. This abrasion protection thus, enables greater first grit 18 retention by the matrix composite material 20.

In alternative embodiments, the large grit particles 18 can comprise hard materials. In an exemplary embodiment, the grit 18 can comprise, zirconia, aluminum di-boride, aluminum nitride, aluminum nitride-carbon, or diamond. An exemplary embodiment can include grit 18 from a DURALUM ATZ II R brand from Washington Mills, of dense fused alumina-zirconia refractor grain.

In an exemplary embodiment, the second grit 22 can range in size from about 0.01 to about 0.10 mm nominally. The second grit particles 22 can comprise the same material as the larger grit particles 18. Other materials can be employed for the small grit 22. In an exemplary embodiment, the second grit particles 22 can comprise a smaller, high modulus material that is less costly than the first grit particle 18. Thus, the larger first grit particle 18 can be a more expensive material such as, diamond and the second grit 22 can be less expensive since, it does not perform the bulk of the cutting and instead performs the function of improving the strength of the entire coating 16.

The smaller second grit particles 22 function to increase the strength of the matrix material 20 and buttress the first grit particles 18 increasing the load resistance of the first grit 18.

The abrasive coating 16 can include a base layer 24 bonded to the blade tip 14. The base layer 24 can be the same material as the matrix 20. The base layer 24 can be from about 1 to about 100 microns in thickness. In an exemplary embodiment, the base layer 24 can be from about 25 to about 50 microns in thickness. The base layer 24 can be optionally applied.

An adhesion layer 26 comprising the plating material utilized in the matrix 20 can be applied to the base layer 24 or can be coated directly to the blade tip 14. The adhesion layer 26 prepares the surface of the tip 14 for the first grit 18 to adhere to during application of the first grit 18. The adhesion layer 26 can comprise the same basic material as the matrix 20 or other beneficial materials that bind the first grit 18 to the blade tip 14 or alternatively the base layer 24. In an exemplary embodiment the adhesion layer 24 comprises a Ni alloy matrix material.

The exemplary abrasive coating 16 includes a portion of each first grit particle 18 projecting outward above the surface of the matrix material 20, thereby enabling favorable rubbing interaction with metal or ceramic seals during engine operation. The unexposed portion of the first grit particles 18 are surrounded by matrix material 20 and second grit 22. The first grit particles 18 can be spaced apart from each other with a minimal distance of separation and arranged uniformly spaced apart. The matrix material 20 and smaller second grit 22, as well as first grit particles 18 can be securely bonded to the blade tip 14.

The combination of the smaller grit 22 blended with the matrix material 20 securely bonded and surrounding the grit particles 18 achieve a higher modulus of elasticity than merely having only the matrix 20 surrounding the first grit 18. The combination of smaller grit 22 and matrix 20 also provides superior support to the first grit 18.

The abrasive blade tip coating takes advantage of the characteristics of a composite structure by distributing cutting load from individual highly loaded grit particles to adjacent grit particles, thus reducing stress at the matrix, which holds individual grit particles. The abrasive blade tip coating reduces inter-particle spacing and grit loading. The exemplary abrasive blade tip coating demonstrates superior durability that is associated with the ability of individual grits to withstand higher loads.

Better transfer of loads between abrasive particles allows individual grits to support higher cutting loads before being pulled out of the abrasive composite blade tip. Another benefit of the exemplary abrasive tip coating is that the narrower grit spacing provides better protection of the Ni matrix from wear by abradable rub debris. The exemplary abrasive composite blade tip coating enables for retention of the matrix that also relates to better grit retention.

There has been provided an abrasive blade tip coating. While the abrasive blade tip coating has been described in the context of specific embodiments thereof, other unforeseen alternatives, modifications, and variations may become apparent to those skilled in the art having read the foregoing description. Accordingly, it is intended to embrace those alternatives, modifications, and variations which fall within the broad scope of the appended claims.

What is claimed is:

1. An abrasive blade tip coating comprising:
a blade tip having a top surface;
a plurality of first grit particles dispersed over said top surface of said blade tip;
a plurality of second grit particles closely packed between each of said plurality of first grit particles, said second grit particles having a nominal size smaller than said first grit particle; and
a matrix material bonded to said top surface; said matrix material envelops said second grit particles and said matrix material bonds to and partially surrounds said first grit particles, wherein said first grit particles extend above said matrix material and said second grit particles relative to said top surface.

2. The coating according to claim 1, wherein said first grit particles comprise a SiC material.

3. The coating according to claim 1, wherein said matrix material comprises a matrix formed from MCrAlY, wherein M is Ni or Co.

4. The coating according to claim 1, wherein said second grit particles comprise the same material as said first grit particles.

5. The coating according to claim 1, further comprising:
an adhesion layer coupled to said top surface, wherein said adhesion layer is configured to adhere said first grit particles to said top layer.

6. The coating according to claim 5, wherein said adhesion layer comprises the same material as said matrix material.

7. The coating according to claim 1, wherein said matrix material and said second grit particles combined comprise a modulus of elasticity greater than said matrix material alone.

8. A turbine engine component comprising:
an airfoil portion on having a tip;
a composite abrasive coating bonded to said tip;
said composite abrasive coating comprising an adhesion layer bonded to said tip;
a layer of first grit particles bonded to said adhesion layer;
a plurality of second grit particles dispersed around said first grit particles, said second grit particles being smaller than said first grit particles; and
said second grit particles enveloped in a matrix material surrounding an unexposed portion of said first grit particles; said matrix material coupled to said adhesion layer.

9. The turbine engine component according to claim 8, wherein said first grit particles are sized from about 0.04 to about 0.15 millimeters.

10. The turbine engine component according to claim 8, wherein said second grit particles are sized from 0.01 to about 0.1 millimeters.

11. The turbine engine component according to claim 8, wherein said matrix material and said second grit particles are configured to distribute a cutting load from individual highly loaded first grit particles to adjacent first grit particles, thereby reducing stress at the matrix material.

12. The turbine engine system according to claim 8, wherein each one of said first grit particles are configured with a grit spacing configured to protect said matrix material from wear by an abradable rub.

13. The turbine engine system according to claim 8, wherein said turbine engine component is a blade.

14. A process for coating a turbine engine blade with an abrasive, said process comprising:
applying an adhesion layer onto a tip of said blade;
adhering a plurality of first grit particles to said adhesion layer, wherein narrow spaces are formed between said first grit particles;
filling said narrow spaces between said first grit particles with a plurality of second grit particles, wherein said second grit particles are smaller than the first grit particles;
enveloping said second grit particles with a matrix material; and
surrounding each of said first grit particles with said matrix material exposing a portion of said first grit particles above said matrix material and said second grit particles.

15. The process of claim 14, further comprising:
spacing said first grit particles apart, wherein said spacing is configured to protect said matrix material from wear by an abradable rub.

16. The process of claim 14, further comprising:
distributing a cutting load from individual highly loaded first grit particles to adjacent first grit particles, thereby reducing stress at the matrix composite material.

17. The process of claim 14, wherein said matrix material and said second grit particles combined comprise a modulus of elasticity greater than said matrix material alone.

18. The process of claim 14, further comprising applying a base layer to said blade tip prior to applying said adhesion layer.
